(19) United States
(12) Patent Application Publication
(10) Pub. No.: US 2025/0102978 A1
(43) Pub. Date: Mar. 27, 2025

(54) HEATER AND IMAGE FORMING DEVICE

(71) Applicant: Toshiba Lighting & Technology Corporation, Kanagawa (JP)

(72) Inventors: Kairi TAMURA, Ehime-ken (JP); Makoto SAKAI, Ehime-ken (JP); Masahiko TAMAI, Ehime-ken (JP); Shinjiro AONO, Kanagawa-ken (JP); Satoko KATO, Ehime-ken (JP); Akio TSUBOUCHI, Ehime-ken (JP); Kousuke UENO, Ehime-ken (JP); Masahiro DOI, Ehime-ken (JP); Tsuyoshi OHASHI, Ehime-ken (JP); Yumi MINEYAMA, Ehime-ken (JP)

(73) Assignee: Toshiba Lighting & Technology Corporation, Kanagawa (JP)

(21) Appl. No.: 18/792,513

(22) Filed: Aug. 1, 2024

(30) Foreign Application Priority Data
Sep. 21, 2023 (JP) 2023-155832

(51) Int. Cl. G03G 15/20

(52) U.S. Cl. CPC G03G 15/2053; G03G 15/2064

(57) ABSTRACT

A heater and an image forming device are provided that can reduce manufacturing costs and suppress temperature variation within the surface of the heater. The heater according to an embodiment includes: a substrate having a plate shape and extending in a first direction; a first heating element provided on one surface side of the substrate and extending in the first direction; a first wiring provided on the one surface side of the substrate and overlapping an end portion of the first heating element in the first direction; a second heating element spaced apart from the first heating element in a second direction perpendicular to the first direction on the one surface side of the substrate, and extending in the first direction; and a second wiring provided on the one surface side of the substrate and overlapping an end portion of the second heating element in the first direction. In the second direction, a first portion where the first heating element and the first wiring overlap is adjacent to a second portion where the second heating element and the second wiring overlap. In the first direction, the first portion is spaced apart from the second portion. In the second direction, the first portion faces the second heating element. In the first direction, the first heating element and the second heating element are not in an inclusive relationship with each other.

### CROSS-REFERENCE TO RELATED APPLICATION

This application claims the priority benefits of Japanese application no. 2023-155832, filed on Sep. 21, 2023. The entirety of the above-mentioned patent application is hereby incorporated by reference herein and made a part of this specification.

### BACKGROUND

### Technical Field

Embodiments of the disclosure relate to a heater and an image forming device.

### Description of Related Art

For example, an image forming device such as a copying machine and a printer is provided with a heater for fixing toner. Generally, such a heater includes a long substrate and a heating element that is provided on one surface of the substrate and extends in the longitudinal direction of the substrate.

In this case, it may be required to heat objects (for example, paper) of different sizes with one heater. Therefore, a heater has been proposed in which heating elements of different lengths are arranged side by side in the short direction of the substrate, and the heating element having an appropriate length is selected and used depending on the size of the object to be heated. However, since the material of the heating element is expensive, providing heating elements of different lengths according to the size of the object to be heated poses the problem of increased manufacturing costs for the heater.

Therefore, a heater has been proposed in which heating elements of different lengths are arranged side by side in the short direction of the substrate, and the end portions of the heating elements of different lengths are aligned at the same position in the longitudinal direction of the substrate. In this way, heating elements of different lengths can be combined and used depending on the size of the object to be heated. Therefore, compared to the case where heating elements of different lengths are simply arranged side by side, the total length of the heating elements, and thus the amount of material for the heating elements, can be reduced. If the amount of material for the heating elements can be reduced, the manufacturing costs of the heater can be reduced.

However, simply combining heating elements of different lengths leads to a new problem of temperature variation within the surface of the heater.

Thus, there has been a demand for development of a technique that can reduce manufacturing costs and suppress temperature variation within the surface of the heater.

### RELATED ART

### Patent Document

[Patent Document 1] Japanese Patent Application Laid-Open No. 2020-115185

The disclosure provides a heater and an image forming device that can reduce manufacturing costs and suppress temperature variation within the surface of the heater.

### SUMMARY

A heater according to an embodiment includes: a substrate having a plate shape and extending in a first direction; a first heating element provided on one surface side of the substrate and extending in the first direction; a first wiring provided on the one surface side of the substrate and overlapping an end portion of the first heating element in the first direction; a second heating element spaced apart from the first heating element in a second direction perpendicular to the first direction on the one surface side of the substrate, and extending in the first direction; and a second wiring provided on the one surface side of the substrate and overlapping an end portion of the second heating element in the first direction. In the second direction, a first portion where the first heating element and the first wiring overlap is adjacent to a second portion where the second heating element and the second wiring overlap. In the first direction, the first portion is spaced apart from the second portion. In the second direction, the first portion faces the second heating element. In the first direction, the first heating element and the second heating element are not in an inclusive relationship with each other.

According to an embodiment of the disclosure, it is possible to provide a heater and an image forming device that can reduce manufacturing costs and suppress temperature variation within the surface of the heater.

### BRIEF DESCRIPTION OF THE DRAWINGS

FIG. 1 is a schematic front view for illustrating the heater according to an embodiment of the disclosure.

FIG. 2 is a schematic rear view for illustrating the heater.

FIG. 3 is a schematic cross-sectional view of the heater in FIG. 1 in the direction of line A-A.

FIG. 4 is a schematic front view for illustrating the heater according to a comparative example.

FIG. 5 is a schematic front view for illustrating the heater according to another comparative example.

FIG. 6 is a schematic front view for illustrating the heater according to another comparative example.

FIG. 7A and FIG. 7B are schematic cross-sectional views of the vicinity of the end portions of the heating elements.

FIG. 8 is a schematic plan view for illustrating the arrangement of the portion where the heating element and the wiring overlap.

FIG. 9 is a graph for illustrating the relationship between the distance and the temperature of the portion where the heating element and the wiring overlap.

FIG. 10 is a schematic plan view for illustrating the shape of the end portion of the heating element according to another embodiment.

FIG. 11 is a schematic view for illustrating the image forming device according to this embodiment.

FIG. 12 is a schematic view for illustrating the fixing part.

### DESCRIPTION OF THE EMBODIMENTS

Hereinafter, embodiments will be illustrated with reference to the drawings. In each drawing, similar components are given the same reference numerals, and detailed description thereof will be omitted as appropriate. In addition, arrows X, Y, and Z in each drawing represent three directions that are perpendicular to one another. For example, the longitudinal direction (for example, length direction) of the substrate is defined as an X direction (corresponding to an example of the first direction), the short direction (for example, width direction) of the substrate is defined as a Y direction (corresponding to an example of the second direction), and the direction perpendicular to a surface of the substrate (for example, thickness direction) is defined as a Z direction.

### (Heater)

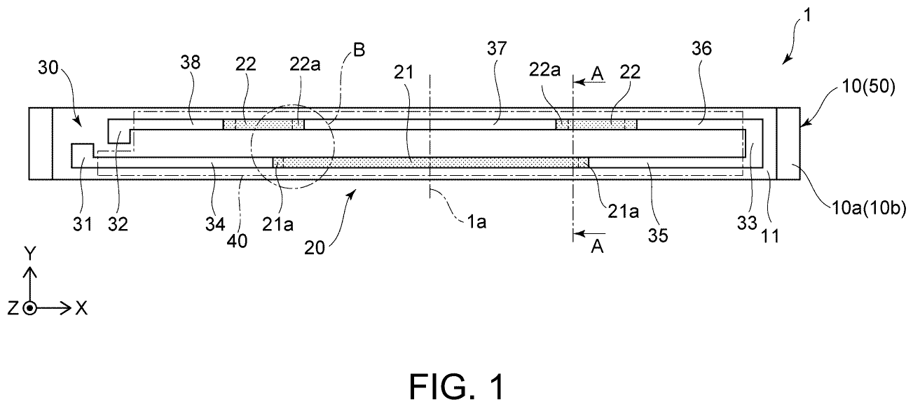

FIG. 1 is a schematic front view for illustrating a heater 1 according to this embodiment.

In addition, FIG. 1 is a view of the heater 1 as seen from the side where a heating portion 20 is provided.

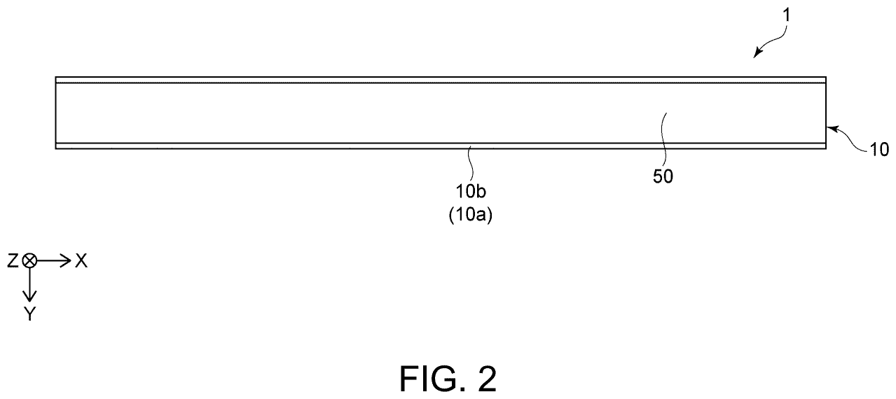

FIG. 2 is a schematic rear view for illustrating the heater 1.

In addition, FIG. 2 is a view of the heater 1 as seen from the side where a warp mitigating portion 50 is provided (the side opposite to the side where the heating portion 20 is provided).

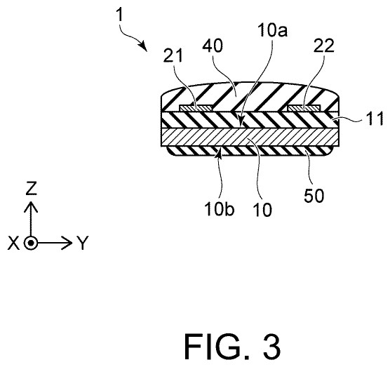

FIG. 3 is a schematic cross-sectional view of the heater 1 in FIG. 1 in the direction of line A-A.

As shown in FIG. 1 to FIG. 3, the heater 1 includes, for example, a substrate 10, an insulating layer 11, the heating portion 20, a wiring portion 30, a protective portion 40, and the warp mitigating portion 50.

The substrate 10 has a plate shape, and has a surface 10a and a surface 10b opposite to the surface 10a. The substrate 10 extends in the X direction. The shape of the substrate 10 as seen from the Z direction is, for example, a long rectangular shape. The thickness of the substrate 10 is, for example, about 0.5 mm to 1.0 mm. The dimension of the substrate 10 in the X direction and the dimension of the substrate 10 in the Y direction can be changed appropriately according to the size, etc. of an object to be heated (for example, paper).

The substrate 10 is made of a material that has heat resistance and high thermal conductivity. The substrate 10 can be made of, for example, a metal such as stainless steel or an aluminum alloy. In addition, the substrate 10 can also be made of, for example, ceramics such as aluminum oxide or aluminum nitride, crystallized glass (glass ceramics), or the like.

In this case, the thermal conductivity of a metal is higher than the thermal conductivity of an inorganic material such as ceramics. Therefore, if the substrate 10 is made of a metal, the temperature variation within the surface of the heater 1 can be reduced. In addition, the rigidity of the substrate 10 can be improved, and the manufacturing costs of the substrate 10 can be reduced.

On the other hand, if the substrate 10 is made of an inorganic material such as ceramics, the insulating layer 11 which will be described later can be omitted. Therefore, the manufacturing process of the heater 1 can be simplified, and the manufacturing costs of the heater 1 can be reduced.

The material of the substrate 10 can be selected appropriately according to the temperature variation, rigidity, manufacturing costs, etc. required for the heater 1. However, in order to reduce temperature variation within the surface of the heater 1, the thermal conductivity of the material of the substrate 10 is preferably 10 [W/(m·K)] or more and 250 [W/(m·K)] or less.

The insulating layer 11 is provided on the surface 10a of the substrate 10 on the side where the heating portion 20 is provided. The insulating layer 11 covers a region of the surface 10a of the substrate 10 where the heating portion 20 and the wiring portion 30 are provided. The insulating layer 11 provides insulation between the substrate 10 made of a metal and the heating portion 20 and the wiring portion 30. Therefore, the insulating layer 11 is made of a material that has heat resistance and insulating properties. The insulating layer 11 can be made of, for example, an inorganic material such as ceramics or a glass material. The insulating layer 11 can be formed, for example, by applying a paste-like material onto the surface 10a of the substrate 10 using a screen printing method or the like, and curing the material using a baking method or the like.

The heating portion 20 converts the applied power into heat (Joule heat). The heating portion 20 is provided on the surface 10a side of the substrate 10. The heating portion 20 is provided, for example, on the insulating layer 11. In a case where the substrate 10 is made of an insulating material such as ceramics, the heating portion 20 can be provided on the surface 10a of the substrate 10.

The heating portion 20 has, for example, a heating element 21 (corresponding to an example of the first heating element) and a heating element 22 (corresponding to an example of the second heating element).

The heating element 21 and the heating element 22 extend, for example, in the X direction. The heating element 22 is spaced apart from the heating element 21 in the Y direction. For example, two heating elements 22 can be provided for one heating element 21. In the X direction, each of the two heating elements 22 is provided in a region between an end portion of the heating element 21 and an end portion of the substrate 10. For example, the center of the heating element 21 is located on a straight line 1a. For example, the two heating elements 22 can be provided at positions that are symmetrical with the straight line 1a as a symmetric axis.

It is also possible to provide one heating element 22 for one heating element 21. However, if two heating elements 22 are provided for one heating element 21, the arrangement of the heating element 21 and the heating elements 22 can be made as described above. If the arrangement of the heating element 21 and the heating elements 22 is made as described above, the object to be heated can be heated substantially uniformly even in a case where the dimension of the object to be heated in the direction perpendicular to the transporting direction changes.

Further, although the above illustrates an example where two types of heating elements are arranged side by side in the Y direction, it is also possible to arrange three or more types of heating elements side by side in the Y direction. However, if the number of heating elements arranged in the Y direction increases, the dimension of the substrate 10 in the Y direction, and thus the dimensions of the heater 1, increases.

The arrangement of the heating element 21 and the heating elements 22 in the X direction will be described in detail later.

In the X direction, the dimension of the heating element 21 may be the same as or different from the dimension of the heating element 22. Although FIG. 1 illustrates a case where the dimension of the heating element 21 in the X direction is longer than the dimension of the heating element 22, the dimension of the heating element 21 may be shorter than the dimension of the heating element 22. The dimension of the heating element 21 and the dimension of the heating element 22 in the X direction can be changed appropriately according to the range of the dimension of the object to be heated that needs to be handled.

The heat generation amount per unit length of the heating element 22 may be the same as or different from the heat generation amount per unit length of the heating element 21. For example, if the resistance value per unit length of the heating element 22 is the same as the resistance value per unit length of the heating element 21, the heat generation amount per unit length of the heating element 22 can be made the same as the heat generation amount per unit length of the heating element 21. For example, if the Y-direction dimension, Z-direction dimension, and material of the heating element 22 are the same as the Y-direction dimension, Z-direction dimension, and material of the heating element 21, the resistance values per unit length, and thus the heat generation amounts per unit length, can be made the same. The resistance value per unit length, and thus the heat generation amount per unit length, may be varied by varying at least one of the Y-direction dimension, Z-direction dimension, and material.

Furthermore, the resistance value per unit length of at least one of the heating element 21 and the heating element 22 can be made substantially constant or can be changed.

In order to make the resistance value per unit length of the heating element substantially constant, the Y-direction dimension, Z-direction dimension, and material of the heating element may be made substantially constant. In order to change the resistance value per unit length of the heating element, at least one of the Y-direction dimension, Z-direction dimension, and material of the heating element may be changed.

The heating element 21 and the heating element 22 can be formed using, for example, ruthenium oxide (RuO₂), a silver-palladium (Ag—Pd) alloy, or the like. The heating element 21 and the heating element 22 can be formed, for example, by applying a paste-like material onto the insulating layer 11 using a screen printing method or the like, and curing the material using a baking method or the like.

The wiring portion 30 is provided on the surface 10a side of the substrate 10. The wiring portion 30 is provided, for example, on the insulating layer 11.

The wiring portion 30 includes, for example, a terminal 31, a terminal 32, a terminal 33, a wiring 34 (corresponding to an example of the first wiring), a wiring 35 (corresponding to an example of the first wiring), a wiring 36, a wiring 37 (corresponding to an example of the second wiring), and a wiring 38.

The terminal 31 and the terminal 32 are provided, for example, near one end portion of the substrate 10 in the X direction. For example, the terminal 32 is spaced apart from the terminal 31 in the X direction.

The terminal 33 is provided, for example, near the other end portion of the substrate 10 in the X direction.

The terminal 31, the terminal 32, and the terminal 33 are electrically connected to, for example, a controller 210 of an image forming device 100, which will be described later, via connectors, wirings, etc. For example, if power is applied to the terminal 31 and the terminal 32, power can be applied to the heating element 21 and the two heating elements 22. Therefore, it is possible to heat an object that has a long dimension in the X direction. For example, if power is applied to the terminal 31 and the terminal 33, it is possible to apply power to the heating element 21 and not apply power to the two heating elements 22. Therefore, when heating an object that has a short dimension in the X direction, power consumption can be reduced.

The wiring 34 extends in the X direction. The wiring 34 is electrically connected to the terminal 31 and one end portion of the heating element 21. In this case, the wiring 34 and the heating element 21 can be electrically connected by overlapping the vicinity of the end portion of the wiring 34 with the vicinity of the end portion of the heating element 21 in the Z direction. As will be described later, the wiring 34 and the terminal 31 can be formed integrally.

The wiring 35 extends in the X direction. The wiring 35 is electrically connected to the terminal 33 and the other end portion of the heating element 21. In this case, the wiring 35 and the heating element 21 can be electrically connected by overlapping the vicinity of the end portion of the wiring 35 with the vicinity of the end portion of the heating element 21 in the Z direction. As will be described later, the wiring 35 and the terminal 33 can be formed integrally.

The wiring 36 extends in the X direction. The wiring 36 is electrically connected to the terminal 33 and one end portion of the heating element 22 provided on the side where the terminal 33 is provided. In this case, the wiring 36 and the heating element 22 can be electrically connected by overlapping the vicinity of the end portion of the wiring 36 with the vicinity of the end portion of the heating element 22 in the Z direction. As will be described later, the wiring 36 and the terminal 33 can be formed integrally.

The wiring 37 extends in the X direction. The wiring 37 is provided between one heating element 22 and the other heating element 22. The wiring 37 is electrically connected to the heating elements 22. In this case, the wiring 37 and the heating element 22 can be electrically connected by overlapping the vicinity of the end portion of the wiring 37 with the vicinity of the end portion of the heating element 22 in the Z direction.

The wiring 38 extends in the X direction. The wiring 38 is electrically connected to the terminal 32 and one end portion of the heating element 22 provided on the side where the terminal 32 is provided. In this case, the wiring 38 and the heating element 22 can be electrically connected by overlapping the vicinity of the end portion of the wiring 38 with the vicinity of the end portion of the heating element 22 in the Z direction. As will be described later, the wiring 38 and the terminal 32 can be formed integrally.

The wiring portion 30 (terminal 31 to terminal 33 and wiring 34 to wiring 38) is formed using a material containing, for example, silver or copper. The wiring portion 30 can be formed, for example, by applying a paste-like material onto the insulating layer 11 using a screen printing method or the like, and curing the material using a baking method or the like.

The protective portion 40 is provided on the insulating layer 11, and covers the heating portion 20 (heating element 21 and heating elements 22) and a part of the wiring portion 30 (wiring 34 to wiring 38). In this case, the terminal 31, the terminal 32, and the terminal 33 of the wiring portion 30 are exposed from the protective portion 40.

The protective portion 40 extends in the X direction. The protective portion 40 has, for example, a function of insulating the heating portion 20 and a part of the wiring portion 30, a function of transferring heat generated in the heating portion 20 to the outside, and a function of protecting the heating portion 20 and a part of the wiring portion 30 from an external force, a corrosive gas, or the like. The protective portion 40 is made of a material that has heat resistance, insulating properties, chemical stability, and high thermal conductivity. The protective portion 40 is made of, for example, an inorganic material such as ceramics or glass. In this case, the protective portion 40 can also be formed using glass added with a filler that contains a material with high thermal conductivity such as aluminum oxide. The thermal conductivity of the glass added with a filler may be, for example, 2 [W/(m·K)] or more.

In addition, the heater 1 may further be provided with a detection portion for detecting the temperature of the heating portion 20 and the temperature of the substrate 10. The detection portion is, for example, a thermistor or the like. The detection portion can be provided on at least one of the side of the substrate 10 where the heating portion 20 is provided and the side of the substrate 10 opposite to the side where the heating portion 20 is provided. For example, the detection portion and the wiring and terminal electrically connected to the detection portion can be provided on the insulating layer 11. In this case, the detection portion and the wiring can be covered with the protective portion 40. The terminal electrically connected to the detection portion can be exposed from the protective portion 40.

Here, when the heating portion 20 generates heat during use of the heater 1, the substrate 10, the insulating layer 11, and the protective portion 40 are heated. When the heating portion 20, the wiring portion 30, the insulating layer 11, and the protective portion 40 are fired during manufacture of the heater 1, the substrate 10, the insulating layer 11, and the protective portion 40 are heated. Furthermore, the materials of the insulating layer 11 and the protective portion 40 are different from the material of the substrate 10. Therefore, when the heater 1 is used or when the heater 1 is manufactured, thermal stress occurs due to the difference in the linear expansion coefficient. If thermal stress occurs on one surface side (for example, the surface 10a side) of the substrate 10, the heater 1 may warp. Further, if the length of the substrate 10 in the short direction (for example, the Y direction) is short, if the length of the substrate 10 in the longitudinal direction (for example, the X direction) is long, or if the thickness of the substrate 10 is thin, the heater 1 is more likely to warp.

In this case, if the heater 1 warps significantly, the distance between the heater 1 and the object to be heated may vary, resulting in uneven heating of the object.

Therefore, as shown in FIG. 2 and FIG. 3, the heater 1 is provided with the warp mitigating portion 50. The warp mitigating portion 50 is provided on the surface 10b of the substrate 10 opposite to the surface 10a. If the warp mitigating portion 50 is provided on the surface 10b of the substrate 10, the thermal stress generated on the surface 10a side of the substrate 10 can be offset by the thermal stress generated on the surface 10b side of the substrate 10. Therefore, it is possible to suppress the heater 1 from warping during use of the heater 1 or during manufacture of the heater 1.

At least one warp mitigating portion 50 may be provided. In a case where a plurality of warp mitigating portions 50 are provided, for example, the plurality of warp mitigating portions 50 can be arranged side by side in the X direction. One warp mitigating portion 50 illustrated in FIG. 2 is provided on the surface 10b of the substrate 10.

Furthermore, the dimension of the warp mitigating portion 50 in the Y direction may be the same as the dimension of the substrate 10 in the Y direction, or may be shorter than the dimension of the substrate 10. The dimension in the Y direction of the warp mitigating portion 50 illustrated in FIG. 2 is shorter than the dimension of the substrate 10 in the Y direction.

The material of the warp mitigating portion 50 may be, for example, an inorganic material such as ceramics or glass.

That is, the number, arrangement, and dimensions of the warp mitigating portions 50 can be changed appropriately according to the warp occurring in the heater 1. The number, arrangement, and dimensions of the warp mitigating portions 50 can be determined appropriately, for example, by conducting experiments or simulations.

Furthermore, in a case where the warping that occurs is small, the warp mitigating portion 50 may be omitted.

Next, the arrangement of the heating element 21 and the heating elements 22 in the X direction will be further described.

First, a comparative example will be described.

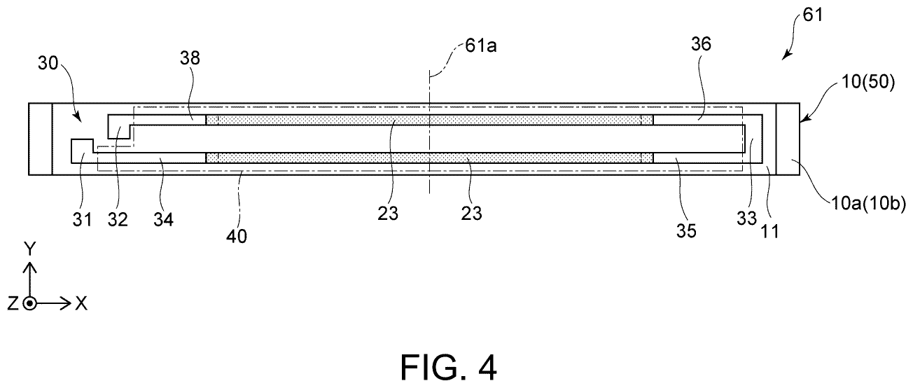

FIG. 4 is a schematic front view for illustrating a heater 61 according to the comparative example.

In addition, FIG. 4 is a view corresponding to FIG. 1.

As shown in FIG. 4, the heater 61 according to the comparative example includes a substrate 10, an insulating layer 11, heating elements 23, a wiring portion 30, a protective portion 40, and a warp mitigating portion 50.

Two heating elements 23 are provided at a predetermined interval in the Y direction. The two heating elements 23 extend in the X direction. The centers of the two heating elements 23 in the X direction are located on a straight line 61a. The dimension of the heating element 23 in the X direction is longer than the dimension of the largest object to be heated. In this way, it is possible to heat objects that have different sizes with one type of heating element 23.

However, if one type of heating element 23 is used to heat objects that have different sizes, the heating element 23 may be unnecessarily long for heating a small object. The material of the heating element 23, such as ruthenium oxide (RuO₂), a silver-palladium (Ag—Pd) alloy, or the like, is expensive, which causes a problem that the manufacturing costs of the heating element 23 become unnecessarily high. Further, when heating a small object, the power consumption also increases.

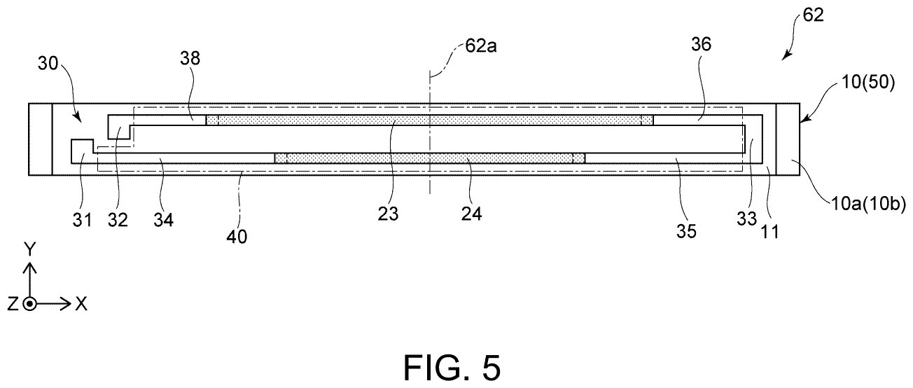

FIG. 5 is a schematic front view for illustrating a heater 62 according to another comparative example.

In addition, FIG. 5 is a view corresponding to FIG. 1.

As shown in FIG. 5, the heater 62 according to the comparative example includes a substrate 10, an insulating layer 11, a heating element 23, a heating element 24, a wiring portion 30, a protective portion 40, and a warp mitigating portion 50.

The heating element 23 and the heating element 24 are provided at a predetermined interval in the Y direction. The center of the heating element 23 in the X direction is located on a straight line 62a. The center of the heating element 24 in the X direction is located on the straight line 62a. The length of the heating element 24 in the X direction is shorter than the length of the heating element 23.

The dimension of the heating element 23 in the X direction is longer than the dimension of the largest object to be heated. The dimension of the heating element 24 in the X direction is longer than the dimension of the smallest object to be heated.

Therefore, when heating the largest object, power is applied to the terminal 32 and the terminal 33 to cause the heating element 23 to generate heat. When heating the smallest object, power is applied to the terminal 31 and the terminal 33 to cause the heating element 24 to generate heat. In this way, unnecessary power consumption can be prevented when heating an object that has a small size. However, since the heating element 23 has a long length, there is room for improvement in terms of reducing the manufacturing costs.

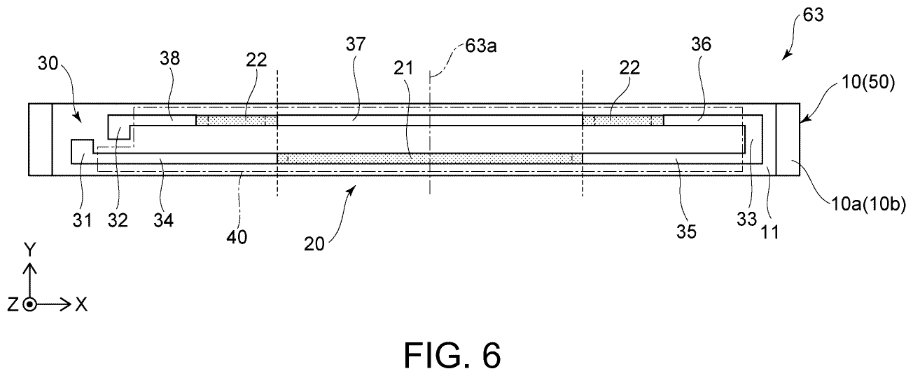

FIG. 6 is a schematic front view for illustrating a heater 63 according to another comparative example.

In addition, FIG. 6 is a view corresponding to FIG. 1.

As shown in FIG. 6, the heater 63 according to the comparative example includes a substrate 10, an insulating layer 11, a heating element 21, heating elements 22, a wiring portion 30, a protective portion 40, and a warp mitigating portion 50, similar to the heater 1 according to this embodiment.

Moreover, the center of the heating element 21 is located on a straight line 63a. Two heating elements 22 are provided at positions that are symmetrical with the straight line 63a as a symmetric axis.

In this case, the end portion of the heating element 22 on the heating element 21 side is provided on an extension line of the end portion of the heating element 21 in the Y direction. That is, in the Y direction, the end portion of the heating element 21 and the end portion of the heating element 22 on the heating element 21 side are at the same position. For example, the distance between the straight line 63a and the end portion of the heating element 21 is the same as the distance between the straight line 63a and the end portion of the heating element 22 on the straight line 63a side.

Furthermore, the dimension of the heating element 21 in the X direction is longer than the dimension of the smallest object to be heated. In the X direction, the distance between the end portions of the heating elements 22 on the sides opposite to the heating element 21 side is longer than the dimension of the largest object to be heated.

Then, when heating the smallest object, power is applied to the terminal 31 and the terminal 33 to cause the heating element 21 to generate heat.

When heating the largest object, power is applied to the terminal 31 and the terminal 32 to cause the heating element 21 and the two heating elements 22 to generate heat. In this case, as described above, in the Y direction, the end portion of the heating element 22 on the heating element 21 side is provided on the extension line of the end portion of the heating element 21, so that the heating element 21 and the two heating elements 22 can be used as one continuous heating element.

In this way, the total length of the heating elements can be made shorter than in the case of two heating elements 23 or the case of the heating element 23 and the heating element 24 as described above. Therefore, the manufacturing costs of the heater can be reduced.

However, it has been found that this causes temperature variation within the surface of the heater 63. If the temperature varies within the surface of the heater 63, there is a risk that the temperature of the object to be heated may vary. As a result of investigation, the inventors have discovered that the temperature variation within the surface of the heater 63 is caused by the temperature near the end portions of the heating elements 21 and 22 being lower than the temperature in the central portions of the heating elements 21 and 22.

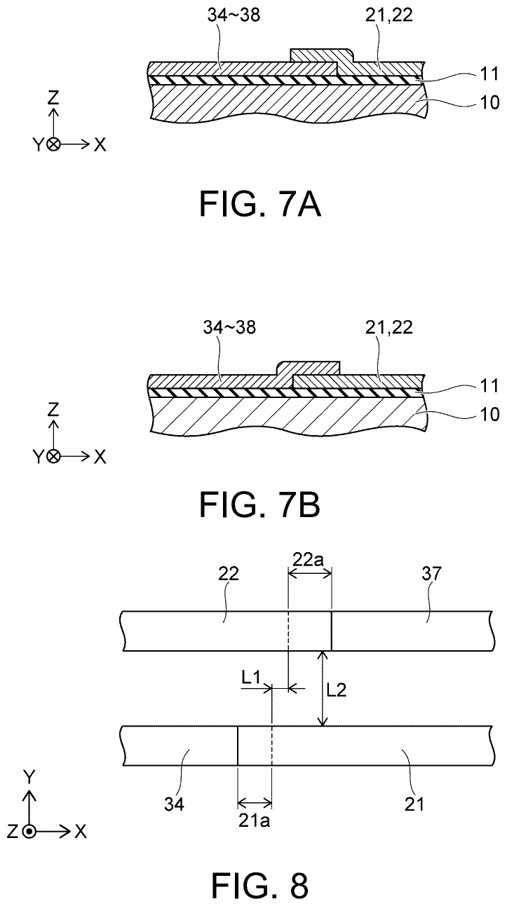

FIG. 7A and FIG. 7B are schematic cross-sectional views of the vicinity of the end portions of the heating elements 21 and 22.

As described above, the heating elements 21 and 22 and the wirings 34 to 38 can be formed by using a screen printing method and a baking method. FIG. 7A shows a case where the wirings 34 to 38 are formed before the heating elements 21 and 22. FIG. 7B shows a case where the heating elements 21 and 22 are formed before the wirings 34 to 38. In the heater 63 illustrated in FIG. 6, the wirings 34 to 38 are formed before the heating elements 21 and 22.

Regardless of whether the heating elements 21 and 22 or the wirings 34 to 38 are formed first, there are portions near the end portions of the heating elements 21 and 22, that overlap the wirings 34 to 38.

As described above, the wirings 34 to 38 contain a low resistance metal such as silver or copper. Therefore, in the portions of the heating elements 21 and 22 that overlap the wirings 34 to 38, current mainly flows through the wirings 34 to 38, and current does not easily flow through the heating elements 21 and 22. Therefore, the heat generation amount in the portions of the heating elements 21 and 22 that overlap the wirings 34 to 38 is less than the heat generation amount in the central portions of the heating elements 21 and 22. Furthermore, since a low resistance metal such as silver or copper has high thermal conductivity, heat near the end portions of the heating elements 21 and 22 easily escapes to the outside via the wirings 34 to 38. Therefore, the temperature near the end portions of the heating elements 21 and 22 is lower than the temperature in the central portions of the heating elements 21 and 22.

In a case where the heating element 21 and two heating elements 22 are used as one heating element, if the overlapping portion between the heating element 21 and the wirings 34 and 35 and the overlapping portion between the heating element 22 and the wiring 37 are continuous or overlap in the X direction as shown in FIG. 6, a low temperature portion is created in the one heating element. Therefore, there is a risk that the temperature may vary within the surface of the heater 63, causing the temperature of the object to be heated to vary.

Thus, in the heater 1 according to this embodiment, in the Y direction, a portion 21a (corresponding to an example of the first portion) where the heating element 21 and the wirings 34 and 35 overlap is adjacent to a portion 22a (corresponding to an example of the second portion) where the heating element 22 and the wiring 37 overlap. Further, the portion 21a is spaced apart from the portion 22a in the X direction, and the portion 21a faces the heating element 22a in the Y direction. In addition, in the X direction, the heating element 21 and the heating element 22 are not in an inclusive relationship with each other. That is, in the Y direction, a part of the heating element 22 is provided at a position overlapping the heating element 21, but the remaining part of the heating element 22 does not overlap the heating element 21. In the Y direction, a part of the heating element 21 is provided at a position overlapping the heating element 22, but the remaining part of the heating element 21 does not overlap the heating element 22. For example, in the X direction, the center line of the heating element 22a is spaced apart from the center line of the heating element 21a.

FIG. 8 is a schematic plan view for illustrating the arrangement of the portion where the heating element and the wiring overlap.

In addition, FIG. 8 is a schematic enlarged view of part B in FIG. 1.

Furthermore, although FIG. 8 illustrates the portion where the heating element 21 and the wiring 34 overlap, the portion where the heating element 21 and the wiring 35 overlap is similar.

As shown in FIG. 8, in the X direction, the portion 21a where the heating element 21 and the wiring 34 overlap is spaced apart from the portion 22a where the heating element 22 and the wiring 37 overlap.

In this way, the heating element 22 having a high temperature can be adjacent to the vicinity of the portion 21a having a low temperature in the Y direction. Therefore, the heat from the heating element 22 can be transferred to the vicinity of the portion 21a. Additionally, the heating element 21 having a high temperature can be adjacent to the vicinity of the portion 22a having a low temperature in the Y direction. Therefore, the heat from the heating element 21 can be transferred to the vicinity of the portion 22a.

As a result, the temperature variation within the surface of the heater 1 can be suppressed.

The temperature near the end portion of the heating element 22 on the side opposite to the heating element 21 side is also lower than the temperature in the central portion of the heating element 22. However, the vicinity of the end portion of the heating element 22 on the side opposite to the heating element 21 side can be provided outside the object to be heated. Therefore, even if the temperature near the end portion of the heating element 22 on the side opposite to the heating element 21 side becomes lower than the temperature in the central portion of the heating element 22, variation in the temperature of the object to be heated can be suppressed.

Furthermore, similar to the heater 63 described above, the total length of the heating elements can be made shorter than in the case of two heating elements 23 or the case of the heating element 23 and the heating element 24. Therefore, the manufacturing costs of the heater can be reduced.

Next, the arrangement of the portion where the heating element and the wiring overlap will be further described.

As shown in FIG. 8, the distance in the X direction between the portion 21a where the heating element 21 and the wiring 34 overlap and the portion 22a where the heating element 22 and the wiring 37 overlap is L1 (mm). The distance in the Y direction between the heating element 21 and the heating element 22 is L2 (mm).

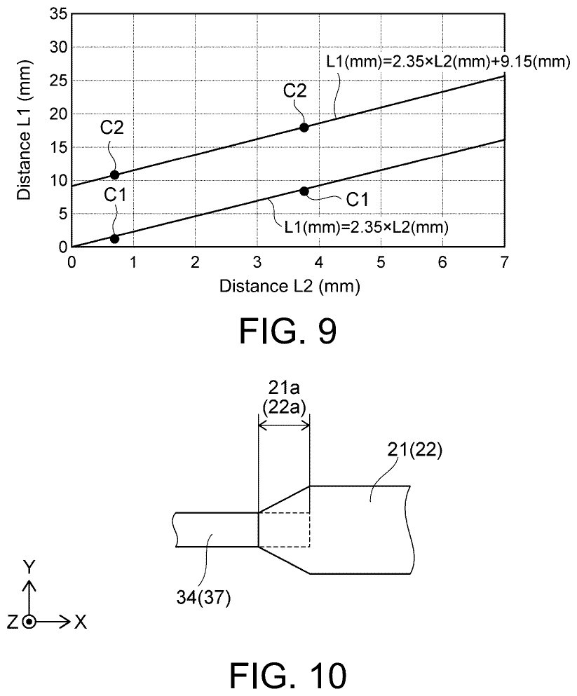

FIG. 9 is a graph for illustrating the relationship between the temperature of the portion 21a and the temperature of the portion 22a, and the distance L1 (mm) and the distance L2 (mm).

C1 in FIG. 9 indicates a case where the temperature of the portion 21a and the temperature of the portion 22a are 95% of the temperature in the central portion of the heating element 21 or the heating element 22. C2 indicates a case where the temperature of the portion 21a and the temperature of the portion 22a become the temperature in the central portion of the heating element 21 or the heating element 22.

As can be seen from FIG. 9, if “L1 (mm)=2.35×L2 (mm),” the temperature of the portion 21a and the temperature of the portion 22a can be set to 95% of the temperature in the central portion of the heating element 21 or the heating element 22. That is, in practice, the heating element 21 and the heating element 22 can be regarded as one heating element.

Furthermore, if “L1 (mm)=2.35×L2 (mm)+9.15 (mm),” the temperature of the portion 21a and the temperature of the portion 22a can be set to the temperature in the central portion of the heating element 21 or the heating element 22. That is, the heating element 21 and the heating element 22 can be regarded as one heating element.

Therefore, by setting “2.35×L2 (mm)≤L1 (mm)≤2.35×L2 (mm)+9.15 (mm),” it is possible to suppress temperature variation within the surface of the heater 1.

FIG. 10 is a schematic plan view for illustrating the shape of an end portion of a heating element according to another embodiment.

In addition, although FIG. 10 illustrates the portion where the heating element 21 (heating element 22) and the wiring 34 (wiring 37) overlap, the portion where the heating element 21 and the wiring 35 overlap is similar.

As shown in FIG. 10, the dimension (width dimension) of the heating element 21 (heating element 22) may differ from the dimension (width dimension) of the wiring 34 (wiring 37) in the Y direction. In such a case, in the portion 21a (portion 22a), the dimension in the Y direction near the end portion of the heating element 21 (heating element 22) can be made to change gradually or change stepwise toward the end portion of the heating element 21 (heating element 22). In the case illustrated in FIG. 10, the dimension near the end portion of the heating element 21 (heating element 22) gradually decreases toward the end portion of the heating element 21 (heating element 22).

In this way, the temperature of the portion 21a (portion 22a) can be increased.

In FIG. 10, the dimension near the end portion of the heating element 21 (heating element 22) is changed over the entire area of the portion 21a (portion 22a), but the dimension near the end portion of the heating element 21 (heating element 22) may be changed over at least a part of the area of the portion 21a (portion 22a).

### (Image Forming Device)

In one embodiment of the disclosure, an image forming device 100 including the heater 1 can be provided. The above description of the heater 1 and modifications of the heater 1 (for example, modifications in which components have been added, deleted, or redesigned as appropriate by a person skilled in the art and which incorporate the features of the disclosure) can all be applied to the image forming device 100.

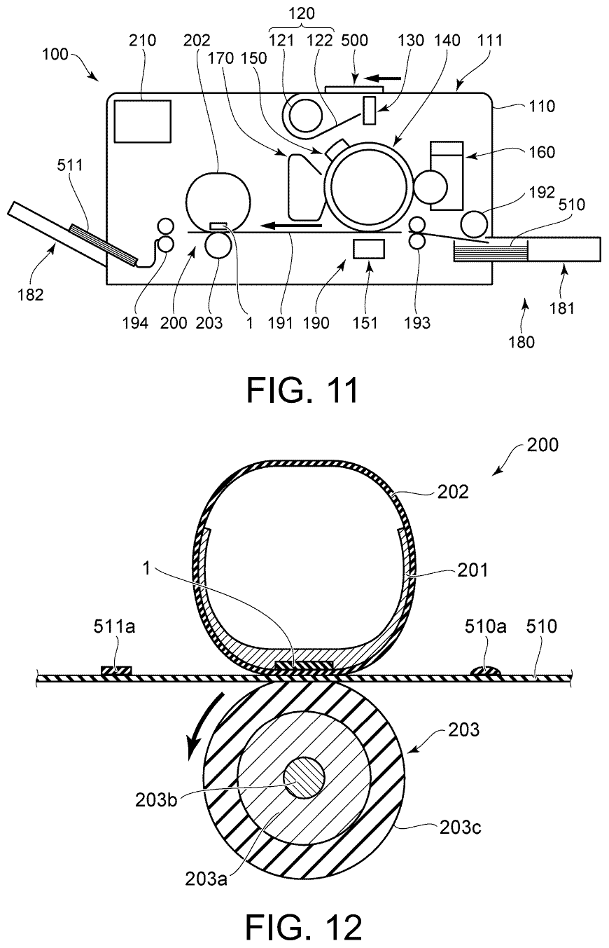

As an example, the following illustrates a case where the image forming device 100 is a copying machine. However, the image forming device 100 is not limited to a copying machine, and may be any device that is provided with a heater for fixing toner. For example, the image forming device 100 can also be a printer, a rewritable card reader/writer, or the like. FIG. 11 is a schematic view for illustrating the image forming device 100 according to this embodiment.

FIG. 12 is a schematic view for illustrating a fixing part 200.

As shown in FIG. 11, the image forming device 100 includes, for example, a frame 110, an illumination part 120, an imaging element 130, a photosensitive drum 140, a charging part 150, a discharging part 151, a developing part 160, a cleaner 170, a storage part 180, a transport part 190, the fixing part 200, and a controller 210.

The frame 110 has a box shape, and houses therein the illumination part 120, the imaging element 130, the photosensitive drum 140, the charging part 150, the developing part 160, the cleaner 170, a part of the storage part 180, the transport part 190, the fixing part 200, and the controller 210.

A window 111 using a light-transmitting material such as glass can be provided on the upper surface of the frame 110. An original 500 to be copied is placed on the window 111. In addition, a moving part for moving the position of the original 500 can be provided.

The illumination part 120 is provided near the window 111. The illumination part 120 includes, for example, a light source 121 such as a lamp, and a reflector 122.

The imaging element 130 is provided near the window 111.

The photosensitive drum 140 is provided below the illumination part 120 and the imaging element 130. The photosensitive drum 140 is provided to be rotatable. On the surface of the photosensitive drum 140, for example, a zinc oxide photosensitive layer or an organic semiconductor photosensitive layer is provided.

The charging part 150, the discharging part 151, the developing part 160, and the cleaner 170 are provided around the photosensitive drum 140.

The storage part 180 includes, for example, a cassette 181 and a tray 182. The cassette 181 is detachably attached to one side of the frame 110. The tray 182 is provided on the side of the frame 110 opposite to the side where the cassette 181 is attached. The cassette 181 stores paper 510 (for example, blank paper) before copying. The tray 182 stores paper 511 on which a copy image 511a is fixed.

The transport part 190 is provided below the photosensitive drum 140. The transport part 190 transports the paper 510 between the cassette 181 and the tray 182. The transport part 190 includes, for example, a guide 191 that supports the paper 510 to be transported, and transport rollers 192 to 194 that transport the paper 510. Furthermore, the transport part 190 can be provided with a motor for rotating the transport rollers 192 to 194.

The fixing part 200 is provided downstream of the photosensitive drum 140 (on the tray 182 side).

As shown in FIG. 12, the fixing part 200 includes, for example, a heater 1, a stay 201, a film belt 202, and a pressure roller 203.

The heater 1 is attached to the stay 201 on the transporting line side of the paper 510. The heater 1 can be embedded in the stay 201. In this case, the side of the heater 1 on which the protective portion 40 is provided is exposed from the stay 201.

The film belt 202 covers the stay 201 in which the heater 1 is provided. The film belt 202 may include, for example, a resin having heat resistance such as polyimide.

The pressure roller 203 is provided to face the stay 201. The pressure roller 203 includes, for example, a core metal 203a, a drive shaft 203b, and an elastic portion 203c. The drive shaft 203b protrudes from an end portion of the core metal 203a and is connected to a drive device such as a motor. The elastic portion 203c is provided on the outer surface of the core metal 203a. The elastic portion 203c is made of an elastic material having heat resistance. The elastic portion 203c may include, for example, a silicone resin or the like.

The controller 210 is provided inside the frame 110. The controller 210 includes, for example, a calculation part such as a CPU (Central Processing Unit) and a memory part in which a control program is stored. The calculation part controls the operation of each element provided in the image forming device 100 based on the control program stored in the memory part. The controller 210 can also include an operation part through which the user inputs copying conditions, a display part that displays the operating status and abnormality indication, etc.

In addition, since known techniques can be applied to the control of each element provided in the image forming device 100, detailed description thereof will be omitted.

Although several embodiments of the disclosure have been illustrated above, these embodiments are presented as examples and are not intended to limit the scope of the disclosure. These novel embodiments can be implemented in various other forms, and various omissions, substitutions, changes, or the like can be made without departing from the spirit of the disclosure. These embodiments and modifications thereof are included in the scope and spirit of the disclosure, and are included in the scope of the disclosure and its equivalents defined in the claims. Furthermore, the above-described embodiments can be implemented in combination with each other.

Additional notes regarding the above-described embodiments are given below.

### (Additional Note 1)

A heater, including:
a substrate having a plate shape and extending in a first direction;
a first heating element provided on one surface side of the substrate and extending in the first direction;
a first wiring provided on the one surface side of the substrate and overlapping an end portion of the first heating element in the first direction;
a second heating element spaced apart from the first heating element in a second direction perpendicular to the first direction on the one surface side of the substrate, and extending in the first direction; and
a second wiring provided on the one surface side of the substrate and overlapping an end portion of the second heating element in the first direction, in which
in the second direction, a first portion where the first heating element and the first wiring overlap is adjacent to a second portion where the second heating element and the second wiring overlap,
in the first direction, the first portion is spaced apart from the second portion,
in the second direction, the first portion faces the second heating element, and
in the first direction, the first heating element and the second heating element are not in an inclusive relationship with each other.

### (Additional Note 2)

The heater according to additional note 1, satisfying the following formula:

$$2.35 \times L 2 ( mm ) ≦ L 1 ( mm ) ≦ 2.35 \times L 2 ( mm ) + 9.15 ( mm ) ,$$

where a distance between the first portion and the second portion in the first direction is L1 (mm), and a distance between the first heating element and the second heating element in the second direction is L2 (mm).

### (Additional Note 3)

The heater according to additional note 1 or 2, in which a resistance value per unit length of the first heating element is substantially constant, and
a resistance value per unit length of the second heating element is substantially constant.

### (Additional Note 4)

The heater according to additional note 1 or 2, in which in the first portion, a dimension near the end portion of the first heating element in the second direction changes gradually or changes stepwise toward the end portion of the first heating element.

### (Additional Note 5)

The heater according to any one of additional notes 1, 2, and 4, in which in the second portion, a dimension near the end portion of the second heating element in the second direction changes gradually or changes stepwise toward the end portion of the second heating element.

### (Additional Note 6)

The heater according to any one of additional notes 1 to 5, in which a material of the substrate has a thermal conductivity of 10 [W/(m·K)] or more and 250 [W/(m·K)] or less.

### (Additional Note 7)

An image forming device, including the heater according to any one of additional notes 1 to 6.

What is claimed is:

1. A heater, comprising:
a substrate having a plate shape and extending in a first direction;
a first heating element provided on one surface side of the substrate and extending in the first direction;
a first wiring provided on the one surface side of the substrate and overlapping an end portion of the first heating element in the first direction;
a second heating element spaced apart from the first heating element in a second direction perpendicular to the first direction on the one surface side of the substrate, and extending in the first direction; and
a second wiring provided on the one surface side of the substrate and overlapping an end portion of the second heating element in the first direction,
wherein in the second direction, a first portion where the first heating element and the first wiring overlap is adjacent to a second portion where the second heating element and the second wiring overlap,
in the first direction, the first portion is spaced apart from the second portion,
in the second direction, the first portion faces the second heating element, and
in the first direction, the first heating element and the second heating element are not in an inclusive relationship with each other.

2. The heater according to claim 1, satisfying the following formula:
$$2.35 \times L 2 ( mm ) ≦ L 1 ( mm ) ≦ 2.35 \times L 2 ( mm ) + 9.15 ( mm ) ,$$
where a distance between the first portion and the second portion in the first direction is L1 (mm), and a distance between the first heating element and the second heating element in the second direction is L2 (mm).

3. The heater according to claim 1, wherein a resistance value per unit length of the first heating element is substantially constant, and
a resistance value per unit length of the second heating element is substantially constant.

4. The heater according to claim 1, wherein in the first portion, a dimension near the end portion of the first heating element in the second direction changes gradually or changes stepwise toward the end portion of the first heating element.

5. The heater according to claim 1, wherein in the second portion, a dimension near the end portion of the second heating element in the second direction changes gradually or changes stepwise toward the end portion of the second heating element.

6. The heater according to claim 1, wherein a material of the substrate has a thermal conductivity of 10 [W/(m·K)] or more and 250 [W/(m·K)] or less.

7. An image forming device, comprising the heater according to claim 1.
